(19) United States
(12) Patent Application Publication
(10) Pub. No.: US 2004/0134953 A1
(43) Pub. Date: Jul. 15, 2004

(54) Multi positionable rack for a pick up truck bed

(76) Inventor: Carlos Valadez Perez, Leon (MX)

Correspondence Address: CARLOS VALADEZ PEREZ, 3722 WESTIN AVE., WOODBURY, MN, 55125, US

(21) Appl. No.: 10/339,526

(22) Filed: Jan. 9, 2003

(51) Int. Cl. B60R 7/00; B60R 9/00

(52) U.S. Cl. 224/403; 224/405; 224/924

(57) ABSTRACT

A pick up truck utility rack, includes a curved crossbar of sufficient size to substantially reach opposite ends of a truck bed, each crossbar end being attached to a pivotal locking means designed to be installed on a pick up truck bed and that allows the crossbar to be tilted and securely locked at a plurality of angular positions limited only by the mass and shape of the vehicle. Said pivotal locking means are locked and unlocked by turning a screw with a provided knob.

### BACKGROUND

1. Field of invention

This invention relates to utility racks for pick up trucks , specifically to such a rack composed of one or more pivotable crossbars installed on a pick up truck bed that can be tilted and securely fixed at a plurality of angular positions that the shape of the vehicle body allows in order to perform a variety of functions described thereinafter.

2. Description of Prior art

When cargo is carried on a pick up truck, the user frequently faces these problems to solve:

How to secure objects in place

How to carry items that exceed the dimensions of the truck bed

How to protect the cargo from the sun, rain or unwanted sights

Currently, There are many products on the market that help to solve the problems described above, however, they all present some drawbacks or limitations.

Cargo within a pick up truck bed, unless it substantially fills the area limited by the bed walls, tends to move freely due to the forces generated by the vehicle in movement.

Certainly, straps or bed dividers may be used to overcome this problem, but many times the shape or dimensions of the object to be carried make transporting it cumbersome , so an invention that would provide a strong load anchoring device would be very desirable.

Utility racks are usually installed in the bed of pick up trucks to haul elongated materials or objects like tubes, ladders, posts, canoes and the like above the truck cab height.

Tipically they are built as a welded or bolted together structure, being it collapsible or disassemblable like those described in U.S. Pat. Nos. 5,190,337 / 5,137,320 / 5,303,858 / 4,869,628 / 5,002,324 /5,423,587

These structures are very useful but at the same time present many disadvantages like the increasement of the overall height of the vehicle, thereby difficulting or limiting its use in certain confined areas.

Because they are usually mounted atop the truck bed side wall they also interfere with the use of other bed accessories like bed liners, hard covers and cabs.

When permanently installed, they affect the aesthetical characteristics of the vehicle and when they are collapsible or disassemblable, they turn from an operative position to being inoperative with no alternative uses in between.

A closed camper or bed cover solves the problem of protecting the cargo from the elements, unwanted sights or theft, but they also limit the truck cargo capacity in terms of volume and versatitlity.

As I have presented, there are many products already available and some of them even subject of prior issued patents that may solve the aforementioned situations but no one that may provide a help to deal with them all.

### OBJECTS AND ADVANTAGES

Accordingly, besides the objects and advantages of the previously described products, several objects and advantages of the present invention are:

a)To provide a holding device for cargo and other accessory items, the crossbar may be adjusted and locked in a plurality of angular orientations so that a wide variety of objects may be anchored or attached securely to it.

b)To provide a utility rack that increases the truck bed cargo capacity; this function is enhanced when two crossbars are used.

c)To be used as a structure to support an open or closed cab, roof or cage formed of top and or side panels.

d)To provide a crossbar that may be rotated and locked at any desired position that the truck body allows, so that it can be adapted to be used as an attachment point for a wide variety of loads

e)To provide a load rack which is aesthetically compatible with a pick up truck design, yet being simple and sturdy

f)To provide a rack that does not necessarily have to be removed or taken apart in order to use or install some other commercially available truck bed accessories such as bed liners, hard covers or cabs.

g)To provide a cargo bar that when fully leaned inboard become for the most part out of sight, not affecting the vehicle appearance or increasing its overall dimensions.

h)To provide a mounting point for a variety of accessories like lights, bicycle carriers, side railings, side boxes and cranes.

i)To provide a crossbar unit that can be placed at different points along the base rails and securely fixed by any known means to broaden the cargo handling possibilities.

j)To provide a crossbar that can be made of a single part or constructed of different assemblable sections allowing to modify its dimensions .

These and other objects advantages and features of the present invention will become apparent upon a consideration of the following description of a preferred embodiment and of the drawings forming a part thereof.

### DRAWING FIGURES

FIG. 1 illustrates a perspective view of the preferred embodiment of the utility rack being mounted on a pick up truck.

FIG. 2 is a side elevational view of a crossbar unit with locking means.

FIG. 3 is a parcial exploted perspective view of the crossbar tilt and locking means.

FIG. 4 shows a side elevational view of the tilt and locking means.

FIG. 5 shows the rotational movement of two crossbar assemblies.

FIG. 6 are side and rear views of a pick up truck, showing the turning range of two crossbars units, and other accesories mounted on them.

FIG. 7 shows a side base rail.

FIG. 8 to 11 illustrate different uses and positions of the tilt rack system combined with additional elements.

FIG. 12 shows a side box design to be installed in combination with this invention.

FIG. 13 shows a high side railing designed to be installed in combination with this invention.

FIG. 14 shows two crossbar units being used as a structure for mounting multiple panels forming a cage.

FIG. 15 and 16 shows a plurality of mounting points on the crossbar for attaching other devices.

FIG. 17 shows an attaching device that can be mounted on the crossbar for securing different loads.

### REFERENCE NUMBERS IN DRAWINGS

21 right base rail. 27 fixed grooved disc.

22 horizontal surface of base rail. 28 rotatable grooved disc.

23 pick up truck bed. 29 front crossbar.

24 bed side wall. 30 rear crossbar.

25 vertical surface of base rail. 31 knob.

26 adjustable locking means. 32 fixed disc base.

### SUMMARY

In accordance with the present invention a multi positionable utility rack comprises at least one curved crossbar of sufficient size to substantially reach opposite ends of a truck bed, each crossbar end being attached to a pivotal locking means designed to be attached to a pick up truck bed.

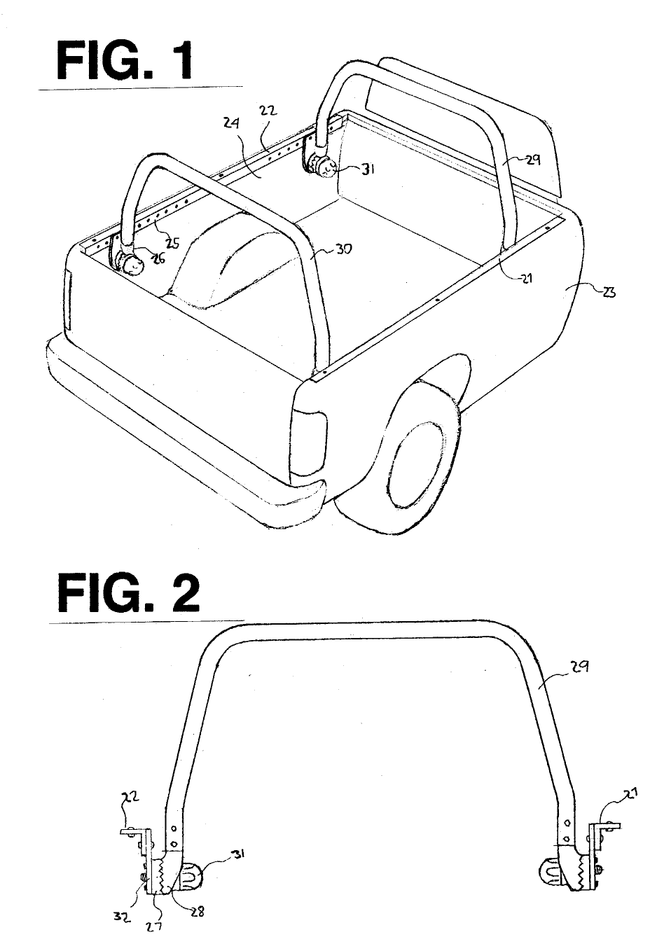

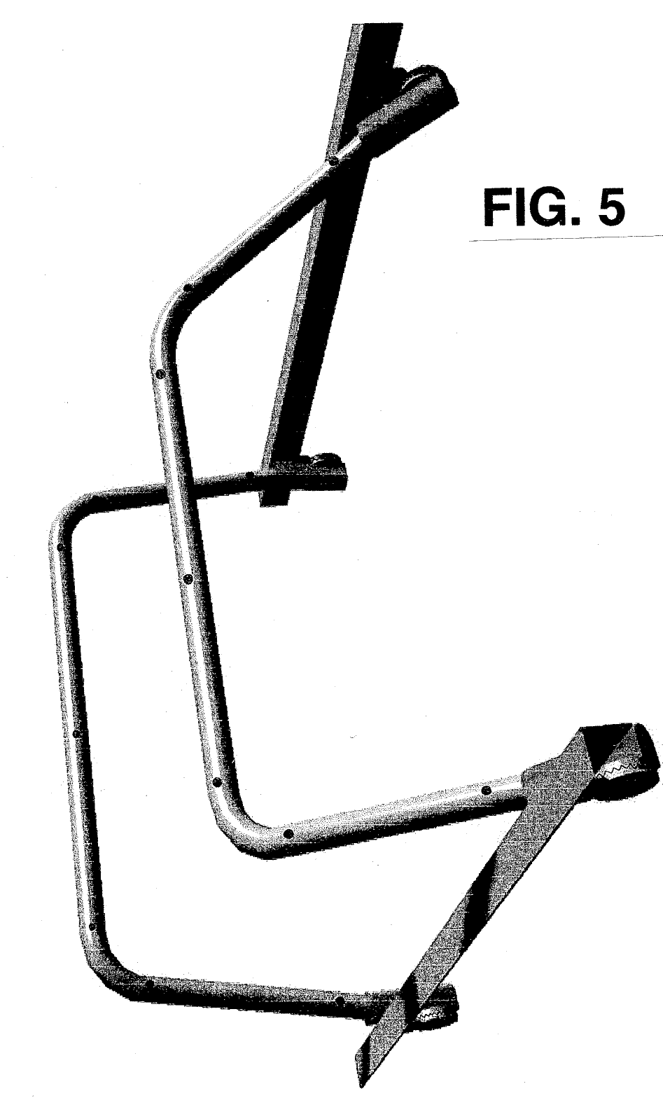

### DESCRIPTION OF THE PREFERRED EMBODIMENT-FIGS. 1 to 5

A typical embodiment of the rack of the present invention is illustrated in FIGS. 1 to 5. In this case a pair of base rails are used (21) whose horizontal surfaces (22) are affixed atop opposite bed side walls (23 and 24) while their vertical surfaces sit against the side walls (23 an 24) and are designed as a rail and guide with evenly spaced perforations (25) where a mounting plate for the pivotable locking means can be positioned and fixed to using the holes that better suit the needs of the user.

The pivotable locking means includes two grooved discs (27 and 28) that may be pivoted relative to each other to give the crossbar (29 and 30) a plurality of angular orientations.

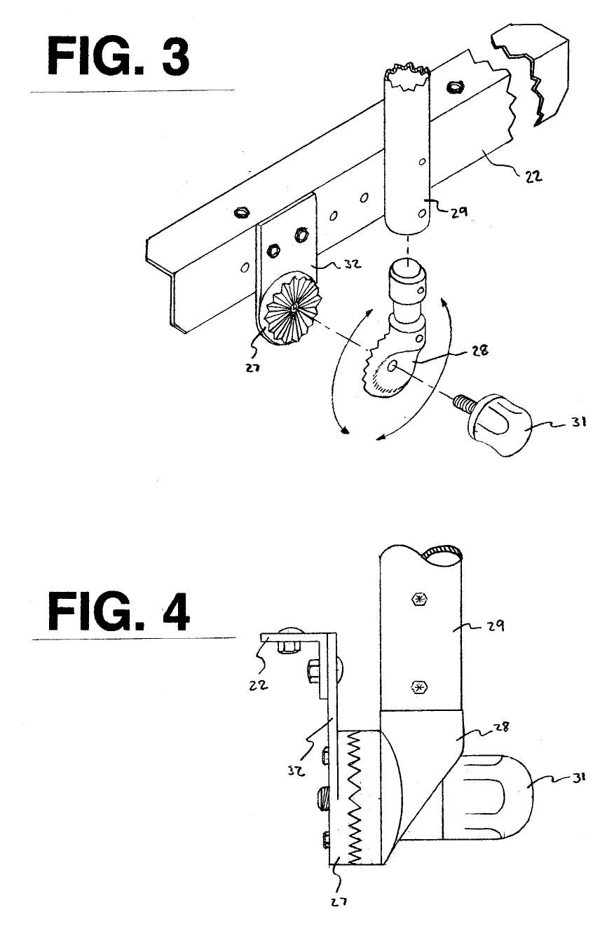

The center of the grooved disc (27) that is mounted on the mounting plate (32) is threaded and a screw with a knob on its end is provided (31) so that an operator turning it with his hand can provide the necessary force to lock or unlock the mechanism. The rotary grooved disc (28) is part of an element designed as a solid attachment base where one of each crossbar ends can be installed and bolted to (FIG. 3).

This curved crossbars (29 and 30) are shaped substantially like an squared inverted “U” having two vertical legs that run upwardly and inwardly and are curved at approximately the truck cab height forming an horizontal beam.

In a preferred embodiment a pair of rack units (FIG. 2) are mounted near opposite ends of the base rails (21).

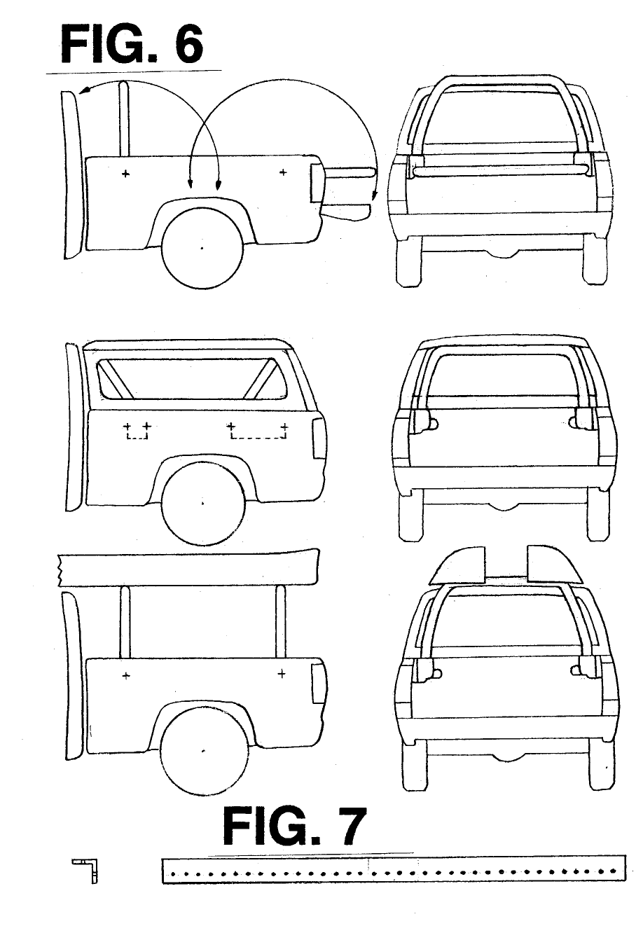

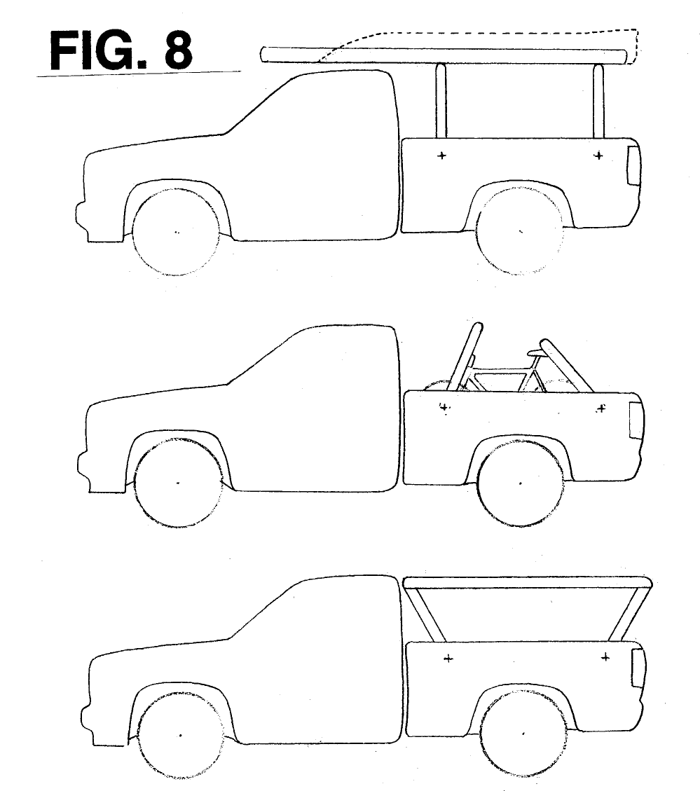

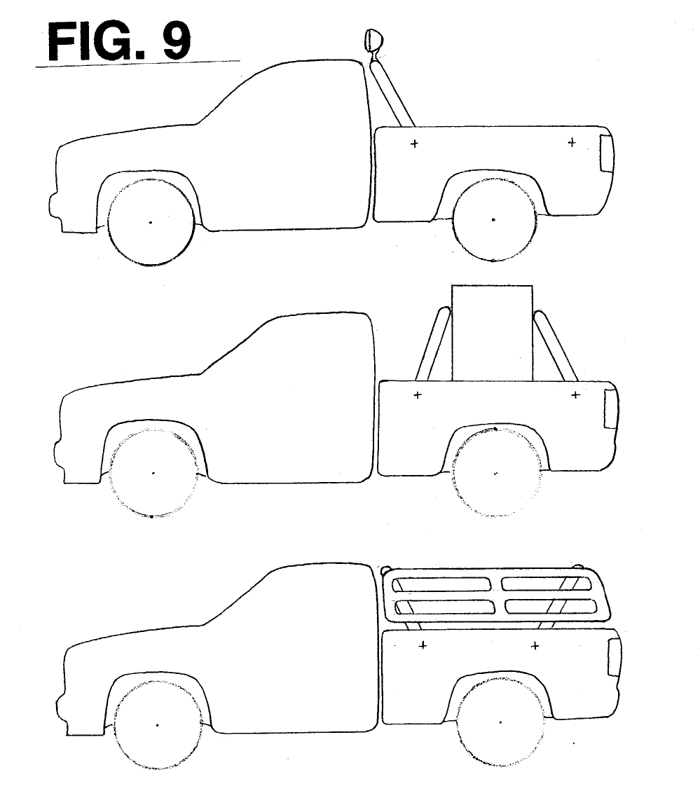

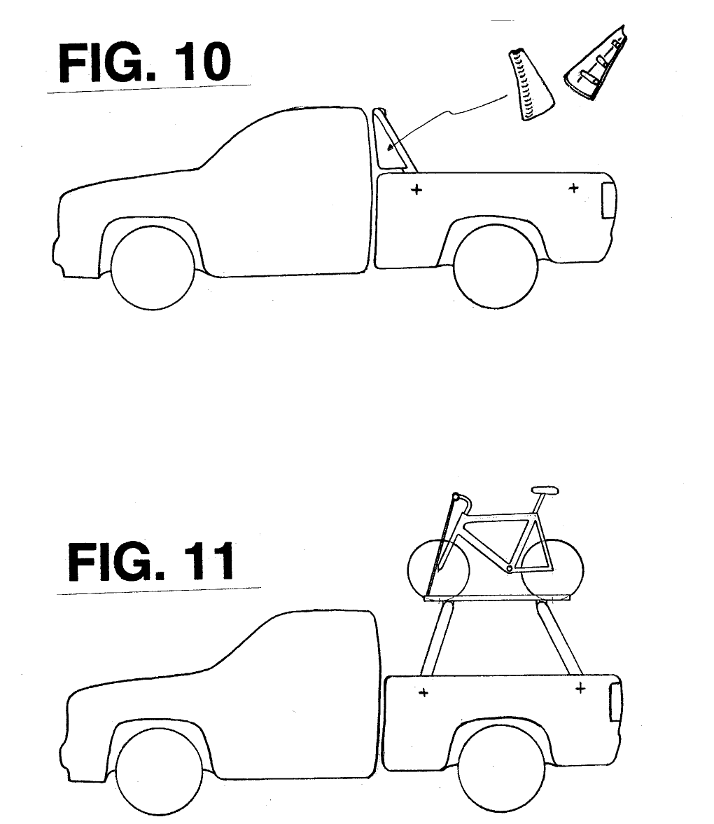

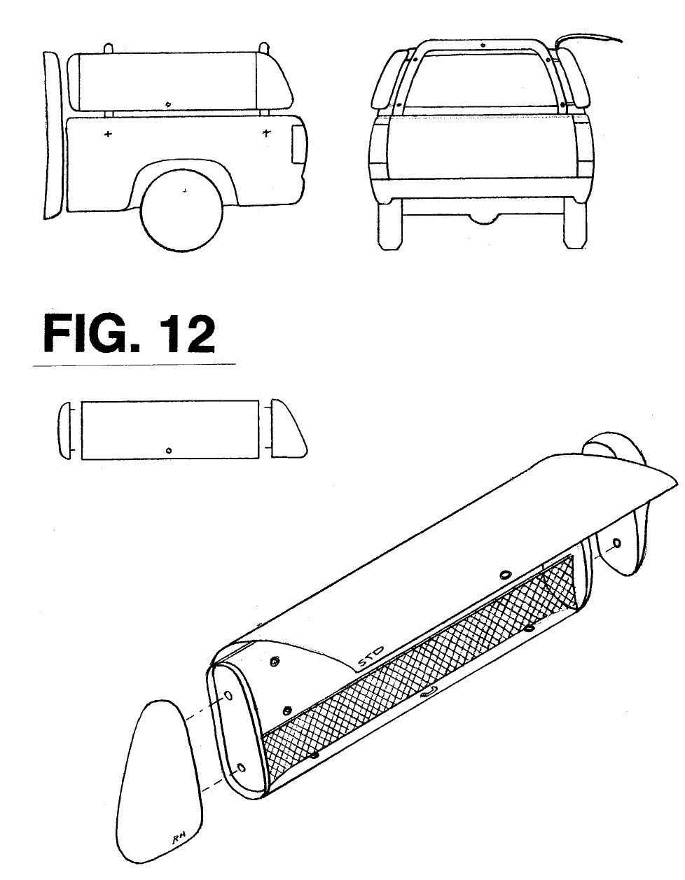

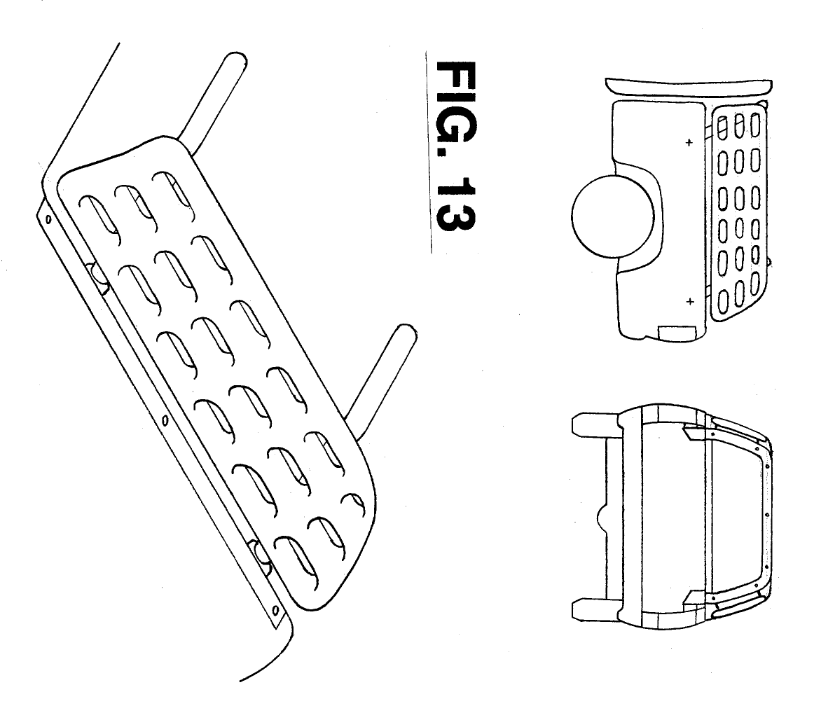

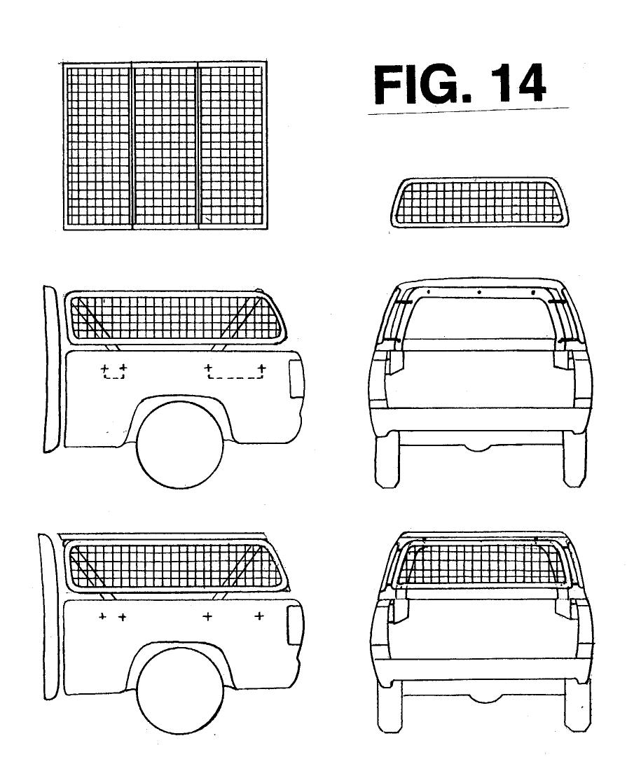

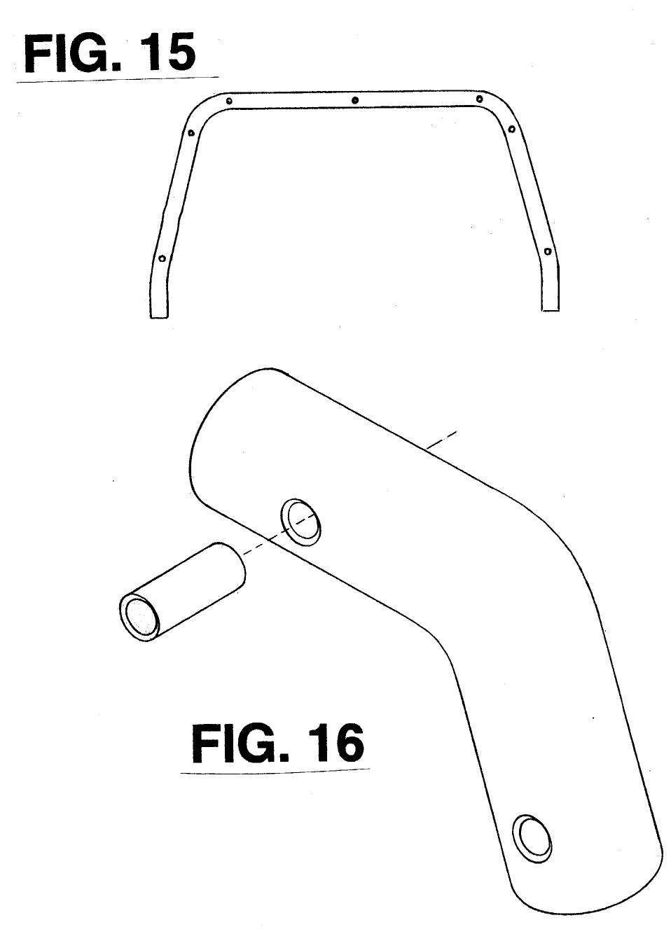

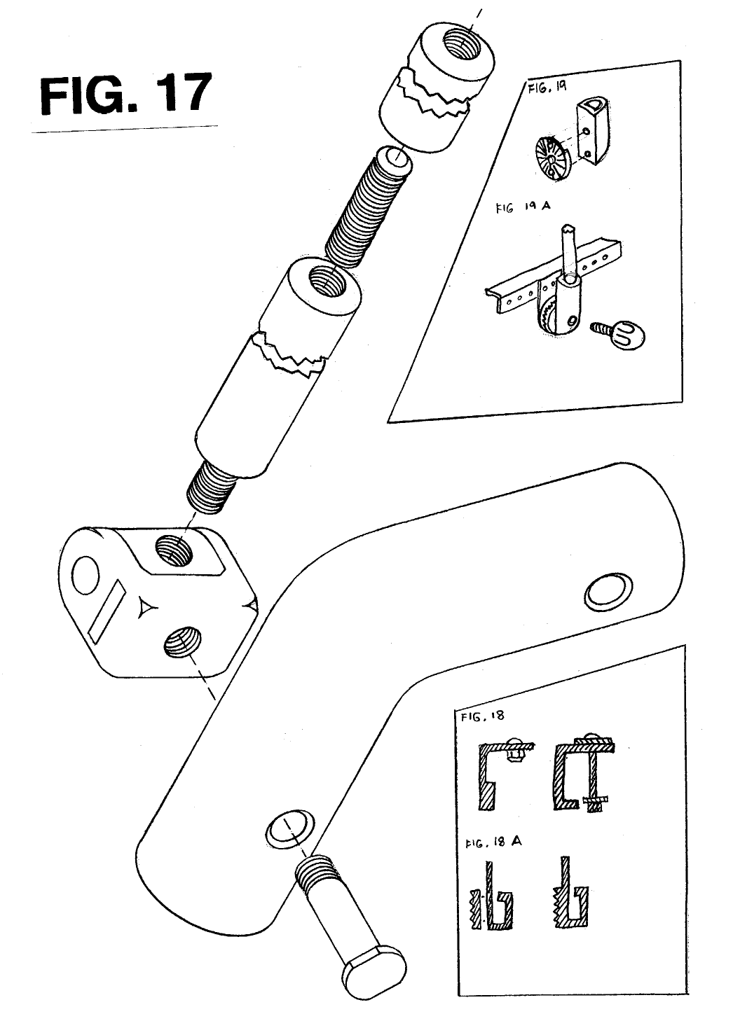

Operation FIGS. 6 to 17:

The manner of using the tilt rack once it is properly mounted on a pick up truck bed is the following:

1) First turn a knob of one of the pivotal locking means installed in one of the ends of a crossbar counterclockwise until the screw to which it is attached advances about ¼ of an inch to unlock a grooved disc assembly.

2) Go to the other endside of the crossbar and while holding it with one hand with the other repeat step 1.

3) Tilt the crossbar to a desired angle and while holding it in place, turn the knob clockwise until you feel the mechanism is firmly locked again.

4) Repeat step 3 with the opposite knob.

By following the same steps, a person can position the crossbars as illustrated on FIGS. 6 to 17, for handling different loads ranging from lightweight to heavy as for carrying bikes, elongated materials, boxes, side boxes, panels constructed of different materials, side railings, etc.

Another feature of the rack system is the possibility of placing the crossbar assembly at different positions along the base rails increasing its versatility. To do this:

1) Unbolt the crossbar assembly from the horizontal rails on both sides of the truck.

2) Slide the crossbar unit to the desired location along the rails.

3) Tighten the bolts to fix the unit in that position.

### CONCLUSION, RAMIFICATIONS AND SCOPE

The possibility of tilting and locking the crossbar at a plurality of desired angles is what gives this invention its true value because it helps to make better use of the available cargo area of a pick up truck bed. Furthermore, the multi positionable rack has provides the user with the following aditional advantages:

When fixed in a vertical position the crossbar horizontal section exceed the height of the truck cab so it can be used individually as a stanchion for rest on elongated materials

When used as a pair, it may become a structure for carrying long objects such as ladders, tubes or canoes that project over the truck cab or for mounting baskets, boxes, platforms or lights.

When slightly inclined, the upper horizontal section of the crossbars become aligned with the cab roof making it a sturdy foundation for canvas awning, a support for a bed cover to be used as a rigid roof or for a close cab composed of a plurality of panels.

It allows the installation of side or top sections made of different materials and configurations such as plastic molded cages, checkered metal wire panel or transparent panels.

When slanted inwards, the gap between the horizontal sections of a pair of crossbars gets shorter, thus allowing the installation of commercially available rack accessories like bike, ski or surf board mounts while leaving the bed completely available for carrying other loads. Speaking of other loads, it is the capacity of transporting them what gives a truck its usefulness and by the use of this rack design this characteristic is enhanced.

Although the description above contains many specificities, these should not be construed as limiting the scope of the invention but as merely providing illustrations of some of the presently preferred embodiments of this invention. For example, the rack units can be tilted and locked at an angle using other mechanisms such as lockable friction plates, support bars, slotted wheels, worm gears, etc.

Thus the scope of the invention should be determined by the appended claims and their legal equivalents, rather by the examples given.

Obviously, many modifications and or variations of the present invention are possible in light of the above teachings, it is therefore understood that the invention is not limited to the specific features described, since the means here disclosed describe preferred forms of putting the invention into effect, and that changes may be made without departing from the spirit or scope of the previously described invention.

I claim:

1) An utility rack to be installed on a pick up truck bed comprising:
a) at least one curved crossbar of sufficient length to substantially reach opposite ends of a truck bed.
b) a pivotal locking means fixed to each curved crossbar end that enables it to be tilted and locked at a plurality of angular positions
c) Means for joining said pivotal locking means to a pick up truck bed.

2) The utility rack of claim 1, wherein said bent crossbar is composed of a plurality of parts.

3) The utility rack of claim 1, wherein said means for joining a pivotal locking means to a pick up truck bed is a rail or track bolted atop a truck bed side

4) The utility rack of claim 1, wherein said bent crossbar has a plurality of perforations provided as accessory attachment means.

5) The utility rack of claim 1, wherein said pivotal locking means is composed of a pair of grooved discs facing each other. One of them is fixed to the truck bed and a second one is fixed to a crossbar end and can be pivoted and locked at a plurality of angular positions by turning a screw that turns inside a grooved perforation in the center of the grooved disc that is fixed to the truck bed.

6) The utility rack of claim 1, wherein said means for joining a pivotal locking means to a pick up truck bed is an extruded metal angle of sufficient length to almost reach opposite ends of a truck bed wall

7) The utility rack of claim 1, wherein said curved crossbar is made with a hollow steel or aluminum tube of sufficient strength and shaped substantially like an squared inverted “U” having two vertical legs that run upwardly and inwardly and are curved at approximately the truck cab height forming an horizontal beam.

8) The utility rack of claim 1, wherein said means for joining a pivotal locking means to a pick up truck bed is an element of sufficient length to almost reach opposite ends of a truck bed wall . In this case a pair of base rails whose horizontal surfaces are affixed atop opposite bed side walls are used. Their vertical surfaces sit against the side walls and are designed as a rail and guide with evenly spaced perforations or teeth where a mounting plate for the pivotable locking means can be moved longitudinally, positioned and fixed to using the holes or teeth that better suit the needs of the user.

9) The utility rack of claim 1, wherein said rotatable grooved disc turns by means of a motorized apparatus.
